(19) United States
(12) Patent Application Publication
(10) Pub. No.: US 2008/0172608 A1
(43) Pub. Date: Jul. 17, 2008

(54) Site builder

(75) Inventors: Zakir Patrawala, Atlanta, GA (US); Mukesh Singh, Cumming, GA (US)

Correspondence Address: HOPE BALDAUFF HARTMAN, LLC, 1720 PEACHTREE STREET, N.W, SUITE 1010, ATLANTA, GA, 30309, US

(73) Assignee: BellSouth Intellectual Property Corporation

(21) Appl. No.: 11/799,156

(22) Filed: May 1, 2007

Related U.S. Application Data
(60) Provisional application No. 60/811,589, filed on Jun. 6, 2006.

(51) Int. Cl. G06F 17/00

(52) U.S. Cl. 715/255; 715/234; 715/243

(57) ABSTRACT

Embodiment of the present disclosure can also be viewed as providing methods for creating a web site. In this regard, one embodiment includes the following steps: receiving a choice of a design template to be used in creating the web site, the design template providing an initial layout for pages of the web site and suggested content; rendering for display a representation of the web site from the design template in a development environment, wherein the representation provides controls for editing content and layout of the web site representation and the rendering produces HTML files that are displayed to a user; and enabling the user to edit design features of the web site based upon a rendered view of the web site in the development environment, a presently displayed representation of a web page having editing tools embedded in the web page. Other methods and systems are also provided

### CROSS-REFERENCE TO RELATED APPLICATION

This application claims priority to copending U.S. provisional application entitled, “Site Builder,” having Ser. No. 60/811,589, filed Jun. 6, 2006, which is entirely incorporated herein by reference.

### TECHNICAL FIELD

The present disclosure is generally related to computer networks and, more particularly, is related to web site production.

### BACKGROUND

A web site is a set of interconnected web pages that are generally prepared and presented as a collection of information. Generally, each web page is a text file containing code written typically in hypertext markup language (“HTML”). Each web page is assigned a uniform resource locator (“URL”), which is generally an address path identifying the server that hosts the web page and the location of the web page on the server. The web pages can be viewed using a web browser, such as Microsoft Internet Explorer® and Mozilla FireFox®. Web browsers interpret the HTML coded file and display its content as the desired web page.

The layout and presentation of the content are dependent upon the specific HTML code within an HTML or Active Server Page (ASP), for example. As a result, each web site is specifically coded to create a particular layout for a unique appearance. Accordingly, changes to the layout and presentation of a web site are time-intensive tasks that are generally performed by a web developer knowledgeable in HTML and not non-technologically-savvy users.

Thus, a heretofore unaddressed need exists in the industry to address the aforementioned deficiencies and inadequacies.

### SUMMARY

Embodiments of the present disclosure provide systems and methods for creating a web site. Briefly described, one embodiment of the system, among others, includes a development server configured to receive a choice of a design template to be used in creating the web site, the design template providing an initial layout for pages of the web site and suggested content and to render for display a representation of the web site from the design template in a development environment. The representation provides controls for editing content and layout of the web site representation, wherein the rendering produces HTML files that are displayed to a user; and enable the user to edit design features of the web site based upon a rendered view of the web site in the development environment, a presently displayed representation of a web page having editing tools embedded in the web page. The editing tools comprise tools for editing pre-existing elements of the web page, in one embodiment. The system further includes a production server configured to host the web site after the development server produces HTML files that are transferred to the production server.

Embodiment of the present disclosure can also be viewed as providing methods for creating a web site. In this regard, one embodiment of such a method, among others, can be broadly summarized by the following steps: receiving a choice of a design template to be used in creating the web site, the design template providing an initial layout for pages of the web site and suggested content; rendering for display a representation of the web site from the design template in a development environment, wherein the representation provides controls for editing content and layout of the web site representation and the rendering produces HTML files that are displayed to a user; and enabling the user to edit design features of the web site based upon a rendered view of the web site in the development environment. The presently displayed representation of a web page has editing tools embedded in the web page, and the editing tools comprise tools for editing pre-existing elements of the web page.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of components of one embodiment of a web site development system in accordance with the present disclosure.

FIG. 2 is a diagram of components of an embodiment of a site builder application such as that utilized in an embodiment of the system of FIG. 1.

FIG. 3 is a diagram of a table of settings configurable within an embodiment of a site builder application such as that shown in FIG. 2.

FIG. 4 is a diagram of an exemplary file used to define templates available for use in designing a web site using the site builder application of FIG. 2.

FIG. 5 is a diagram of an exemplary file used to store user's settings to be used in creating a web site via the site builder application such as that shown in FIG. 2.

FIG. 6 is diagram of custom server controls utilized by an embodiment of the site builder application of FIG. 2.

FIG. 7 is a diagram of objects supported by an embodiment of a site builder application 220, such as that shown in FIG. 2, and the underlying custom server controls used to create them.

FIG. 8 is a flow chart illustrating an embodiment of a process for creating a web site in accordance with the present disclosure.

FIGS. 9-20 are screenshot diagrams of interfaces to an embodiment of a site builder application such as that shown in FIG. 2.

FIG. 21 is a diagram depicting a composition of regions within a design layout and a process of translating content from one layout to another in accordance with the present disclosure.

FIG. 22 is a flow chart diagram illustrating an embodiment of a process for creating a web site in accordance with the present disclosure.

FIG. 23 is a flow chart diagram illustrating an embodiment of a process for creating a web site in accordance with the present disclosure.

FIG. 24 is a flow chart diagram illustrating an embodiment of a process for creating a web site in accordance with the present disclosure.

FIG. 25 is block diagram of a computer that can implement components of the web site development system of FIG. 1.

### DETAILED DESCRIPTION

Referring now to the figures, one embodiment of the present disclosure is a web site development system that provides a web based web site development platform which allows users to create their web site with out the knowledge of HTML (hypertext markup language) or computer programming. As a web based online tool, a site builder platform allows individuals and small businesses to create their web sites without having to learn HTML or hire a programmer. The platform works independent of the operating systems utilized by desktops to access the tool. Therefore, individuals having computers with Windows and Linux operating systems can both utilize components of the web site development system. Web sites established by an embodiment of the present system need not reside on the Internet, but could also reside on an intranet, extranet or other computer network; likewise, any communication system capable of accessing a web site, such as a modem, a network interface card, or a wireless communications system could be used to access a web site created by the present system and method.

Each web page within a web site has content data and presentation logic or “meta data.” Content data is the information displayed on the web page, whether in text, graphics, audio, video or the like. Presentation logic is generally not seen by the user, but specifies the organization, layout and format in which the content data will be presented to the user, such as colors of the background and text, font type, font size, table format, linking relationships, and placement of text and images. Presentation logic encompasses any tag available in HTML that controls web page format.

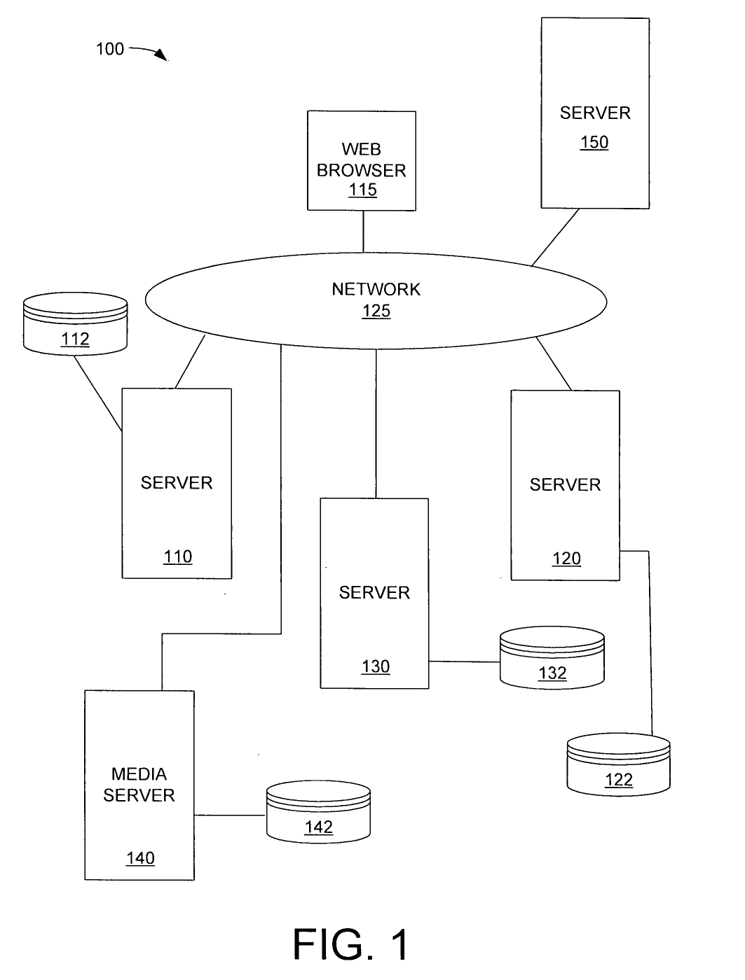

Referring now to FIG. 1, one embodiment of components of a web site development system 100 is illustrated. A browser based web application software developed using Microsoft ASP.NET technology runs on a server 110 with IIS (Microsoft's Internet Information Server) and uses SQL (structured query language) server 120 as its backend database for user authentication in one embodiment. Interfaces of the software are accessed by a web browser 115 via computer network 125. Each of the servers may communicate with one or more databases 112, 122, 132.

In one embodiment, the web site development system 100 uses a file server 130 to store user's files and their web site configurations in a proprietary format. This format helps the system to dynamically generate a web site for building as well as publishing the web site. Users' configurations are stored in XML (eXtensible Markup Language) files and users' web sites are stored in control files within a development environment.

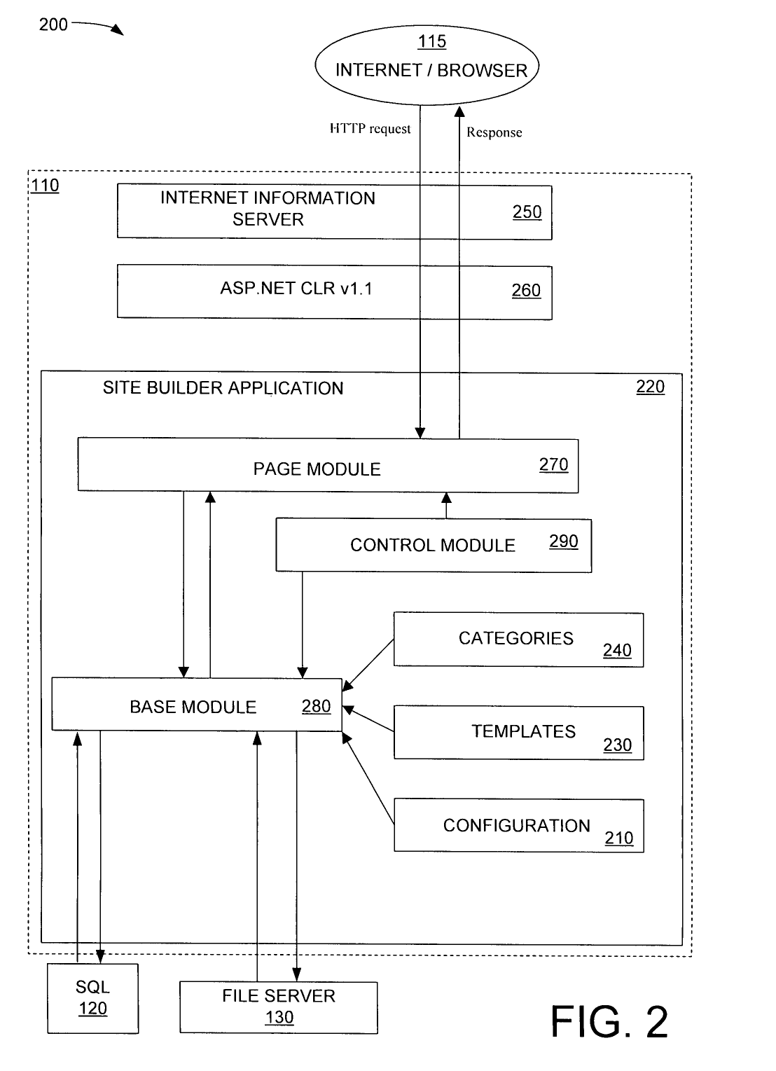

Referring now to FIG. 2, a user's web site may be stored as an ASP.NET .ascx control file format on the file server 130 under a respective user's directory, in one embodiment. As such, each user has their respective folder on file server 130 with their username as the folder name. All sites correspond to a folder or directory name and all pages in that site correspond to a files name within that site folder or directory

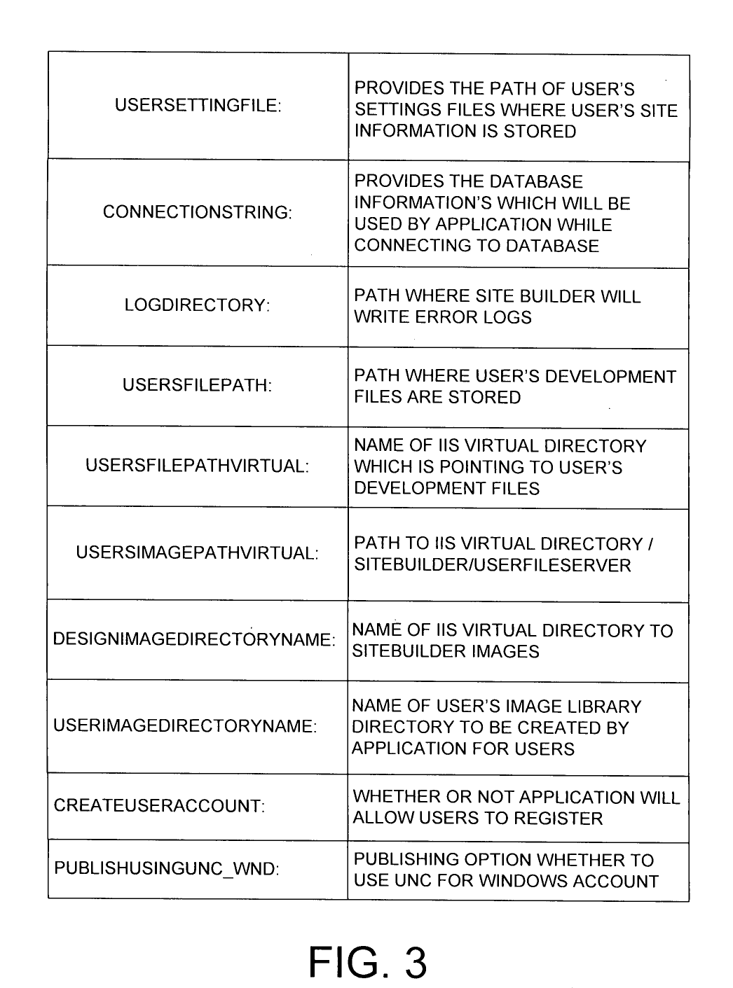

The web application software (“site builder application”) settings 210 are stored in a file at server 110, in one embodiment. This may be an application level configuration that allows the administrator of site builder application and system to customize the setup and its behavior. Some of the settings are shown in FIG. 3. Via authentication measures, the site builder application 220 may authenticate an administrator to the site builder application 220 and direct the administrator to any server or database that will allow the administrator to administrate the system.

Design templates (or templates) 230 are HTML files containing sets of ASP.NET custom controls (and with extension as .ascx). Custom controls are server controls with specific task to yield at development and publishing/rendering. These custom controls have different functions and attributes to yield to a page on the user's web site. These controls are generated by users for a specific task on the page via the site builder platform.

Templates 230 provide the layout and default content for a user to edit/delete and add his or her own contents to his or her web site being developed. In one embodiment, templates 230 may be considered as the building block of a user's web page being developed by the site builder application 220. In one embodiment, templates 230 are stored in a directory of the server 110 hosting the site builder application 220 (e.g., /sitebuilder/design/). For example, in one embodiment, the server 110 is structured such that there is a subdirectory beneath a /sitebuilder/design directory which goes by the name of a particular design template. For example, if a design template with the name “computer consulting” is to be created, first the directory /sitebuilder/design/computerconsulting is created. Then, the template 230 is placed in the directory location, for one embodiment.

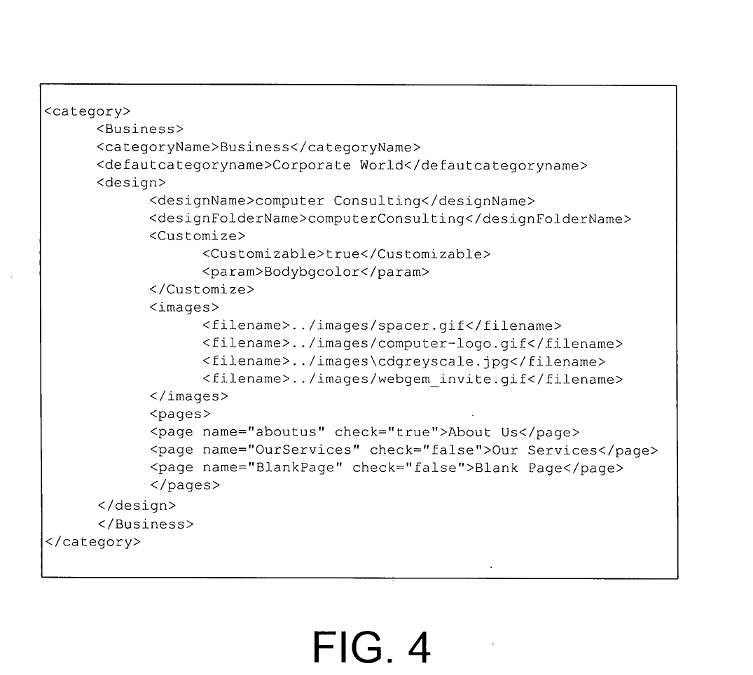

After a new template is created, the template 230 may be defined in a category file 240 so that the site builder application 220 can present a user an option of building a web site using the new template. For example, in one embodiment, templates 230 are defined in a category.xml file (FIG. 4) under a category listing which is applicable for the type of template. In this way, templates 230 may be grouped together with relevant default contents and layouts under a particular category. Accordingly, category.xml 240 may define the category and associated templates, pages, images for the application to choose and present to the user. As further illustration, within a “business” category, all design templates may contain a page name “contact us” or “about us” whereas in a “personal” category, all design templates may contain a page name “about me” or “my interest.”

As mentioned above in one embodiment, each category is defined in category.xml file with a particular format for site builder application 220 to present this category of web site designs to users. Likewise, image files and pages associated with the template 230 are defined in category.xml 240. The associated pages are placed in a design directory (e.g., /sitebuilder/design/) and the images are placed in an images directory (e.g., /sitebuilder/images directory), for one embodiment.

In one embodiment, each user has an image gallery or library where user can upload images to a network location. Further, an image manager may be provided in web pages of the site builder application 220 for the user that allows the user to upload an image once to the image gallery location and then create an image link to the gallery location in as many places within a web site under development and as many times in the site as the user desires without uploading the image repeatedly. The image gallery is generally a central place where images can be uploaded and reused across multiple sites and pages. Once an image is uploaded to the image gallery, a user can choose to have that image placed on any of the user's web pages. Also, in some embodiments, a hyperlink may be specified to images located at another site or network location.

Similar to the image manager, in some embodiments, a document manager and library is provided. With the document manager, a user can upload a document (e.g., .doc file, excel file, pdf file, etc.) and then specify a hyperlink to the document from within a web site created by the user. Likewise, a streaming content manager is provided in some embodiments of the web site development system 100. Therefore, data intended to be streamed from a web site may be uploaded to the streaming content manager and links to the data may be located in one or more pages of the web site.

Managers for storing different data types may be stored on separate servers and databases that are more aptly suited for storing respective content types and provide the ability to publish different type of content on different kinds of servers. From a user's perspective, he or she does not be concerned with how or where a file is being stored when uploading the file. In one embodiment, separate servers are used to store image data, HTML and dynamic content, streaming content (where the server has its own portal), and document files. Accordingly, one or more media servers 140 (and databases 142) may store particular data files to be accessed via a user's web site, as shown in FIG. 1. Advantageously, in one embodiment, each type of manager publishes content on different locations which is configurable, and each manager may follow different URL translation rules. For instance, a media manager may publish to “media.bellsouth.net” servers with URLs formatted for media players corresponding to “mms://” or “rtsp://” instead of “http://”.

Referring back to the subject of templates, in one embodiment, templates 230 provide the layout and default content for user to edit/delete and add contents. In this way, the template file format provides a way for the site builder application 220 to add and edit the objects of the web site being developed. The different layouts of a template file 230 are done by utilizing controls, where the position of each control is marked by placeholder controls above and below the control. The controls correspond to objects of the web site being developed, and the placeholder controls allow the site builder application 220 the option of positioning an object amongst multiple positions. This approach provides the flexibility for a user to keep adding n number of different objects all across the web site. Advantageously, in one embodiment, ASP.NET custom controls store individual objects and placeholder controls are used to identify the object's position.

Within the server 110, each user's individual site is arranged in a directory where each page of the site corresponds to a file in that directory or “development folder”—each file having custom controls. The custom controls render objects dynamically that are displayed as part of a web page either for display to a user during development or for publishing to a user's WWW (World Wide Web) domain during production. Web pages may be transferred to a user's domain using an FTP (file transfer protocol) mechanism which makes them operable on both Windows and Linux operating systems.

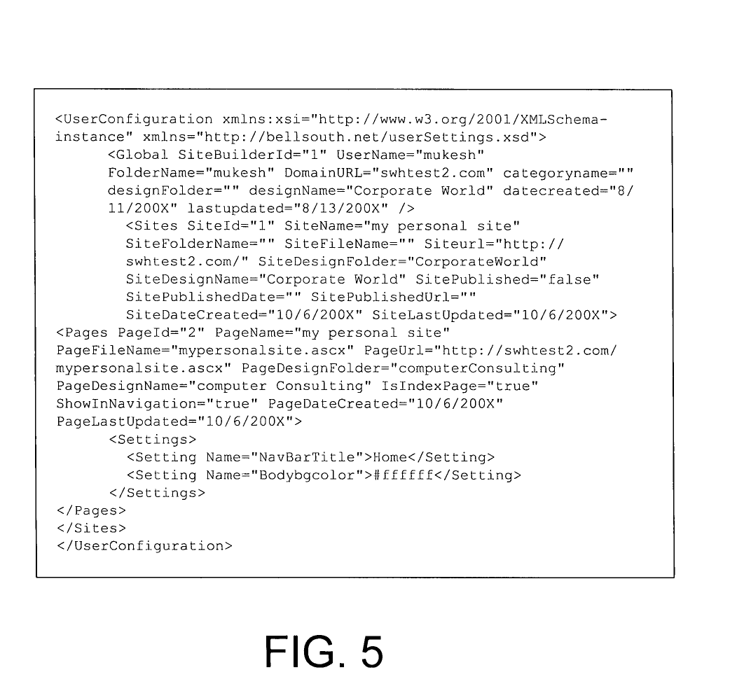

As mentioned, in one embodiment, there is one usersettings.xml file (containing a user's site settings) for each user in his or her development folder for site builder application 220 to read and save user's settings and choices for his or her web sites. An exemplary usersettings.xml file is shown in FIG. 5.

Referring back to FIG. 2, the figure illustrates a single incoming request to the site builder application 220 and associated response that is generated by its components that participates in the request processing life cycle. First, a web browser 215 issues an HTTP request. IIS 250 receives the request and hands it off for processing to ASP.NET ISAPI (Internet Server Application Program Interface) 260. The HTTP Runtime in ASP.NET 260 resolves the request to determine the appropriate HTTP handler it will invoke. ASP.NET 260 uses the Common Language Runtime (CLR) provided by the .NET Framework. This CLR manages execution of the code, such as that corresponding to ASP.NET controls. ASP.NET code is a compiled CLR code instead of interpreted code (ASP). CLR also allows objects written in different languages to interact with each other.

The HTTP handler is invoked which resides in page module 270 of the site builder application 220. It does the real work associated with the request. Page module 270 does some of basic operations like users authentication, request validations, etc.

In one embodiment, the page module is an UI (User Interface) module of the site builder software application 220. The page module 270 contains all the pages of the site builder application 220, which the user accesses while developing a web site. These pages are ASP.NET .aspx files, which contain custom server controls, where the custom server controls are abstractions of HTML and HTTP technologies used in the creation of the browser based application.

The page module 270 interacts with base module 280 to perform a required task and generate the response back to the user. Once the site builder application 220 processes a request, the resulting response is sent back to the web client (which is a web browser 115 in the present example).

The base module 280 uses controls from control module 290 and category/templates to create a user's web site dynamically. The base module 280 performs important operations of the site builder application 220 which includes user's authorization, cookie read/write, reading user's file in memory for rendering/publishing, using control library to add/edit objects on web site, reading application configuration for application customization, etc. In one embodiment, the base module 280 uses a site object corresponding to a web site of a user. The site object loads the pages and allows users to create and edit the web pages of the web site. The site object also performs operations like rendering the web page in the development environment and storing it for further use. The site object also provides the option to a user of generating web pages from control files to HTML files and transfers it to the user's WWW account and domain.

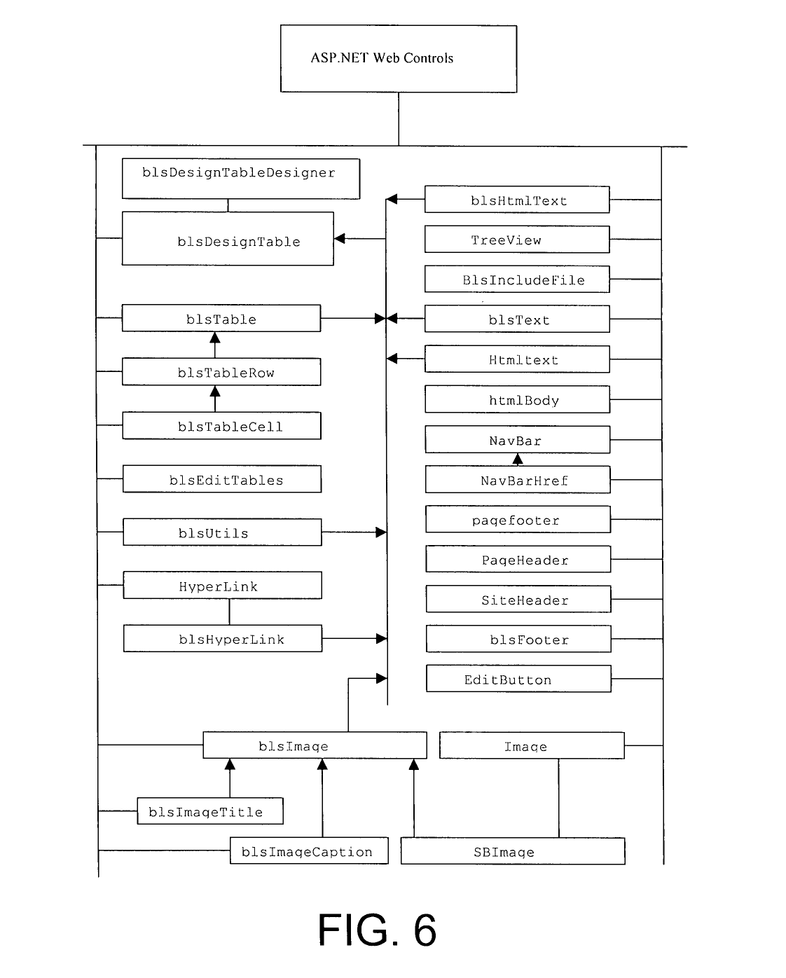

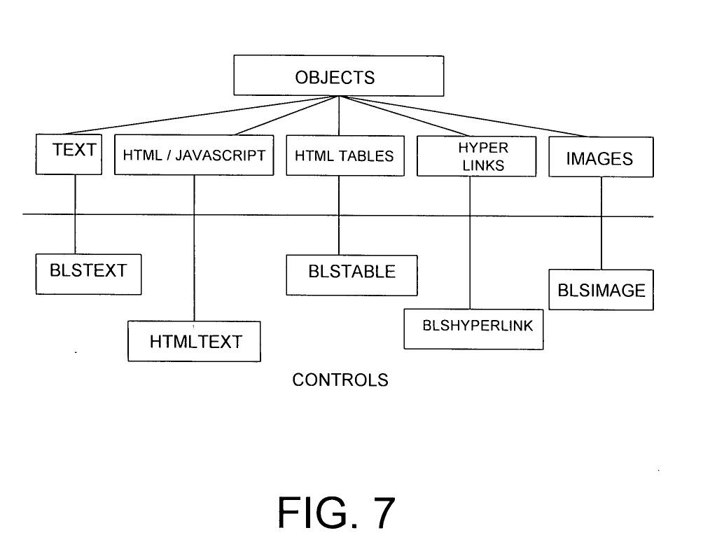

Control module 290 provides a custom control library for the site builder application 220 that is available for a user to use on their site pages. Some of the important custom server controls supported by site builder 220 are listed in FIG. 6. FIG. 7 further illustrates objects supported by the site builder application 220 and their underlying custom server controls used to create them.

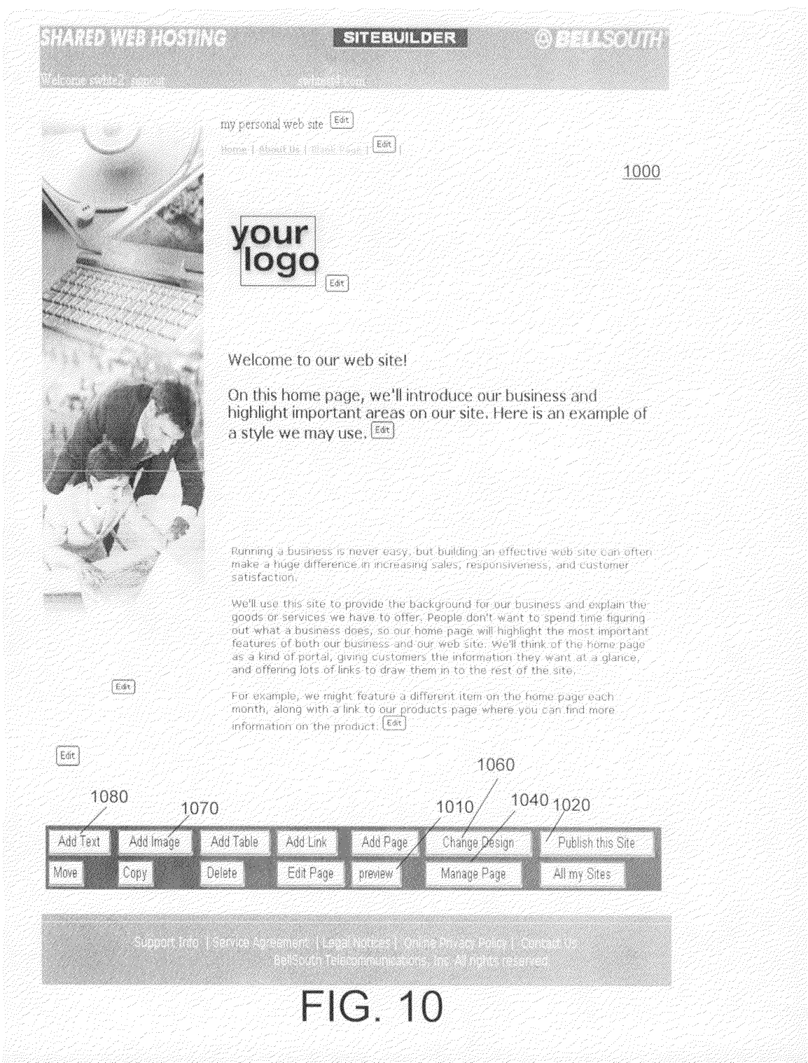

The custom server controls are used by page module 270 to define a user interface. For example “editButton” control in the above control hierarchy presents an HTML edit button for the user, such as that shown in FIG. 10. Each individual edit button performs a specific action for the user and not all edit button perform the same task. Further, the custom server controls are used by base module 280 to create objects or elements of the web site. Each of the server controls individually or in a group represents objects of the web site. Objects generally refer to text/HTML text, hyperlink, images, HTML tables, etc. A user uses these objects to create the web site by placing them at specific positions on the web site being developed. These objects provide a user the flexibility to add at any positions and edit their properties/attributes. They allow user to copy/move and delete them from any position at any time during web site development.

So, when a control is stored in a template file 230, the control is marked up by the site builder application 220 adding an identifier to the control. When the template file 230 is displayed in a user's web browser 115, the identifier mark can then be displayed as an edit or an add interface tool. By a user clicking on the interface tool associated with a control, a user indicates that an operation associated with the tool should be performed. The identifiers selected by a user are used to identify the control that should be added, edited, deleted, etc., in accordance with a user's intentions.

Regarding tables, a site builder control allows for HTML tables to be added to any location on a web page. This gives the flexibility on the page to extend the page length for more contents with custom layouts. It helps in designing the page with custom layouts and formatting. Tables can also be added, edited, deleted, and copied and moved by the user. Further, table properties can be configured by the user.

In other embodiments, the base module 280 uses SQL server 120 for user authentication and reads the users setting files into its in-memory settings. User settings files may be XML file located on file server 130.

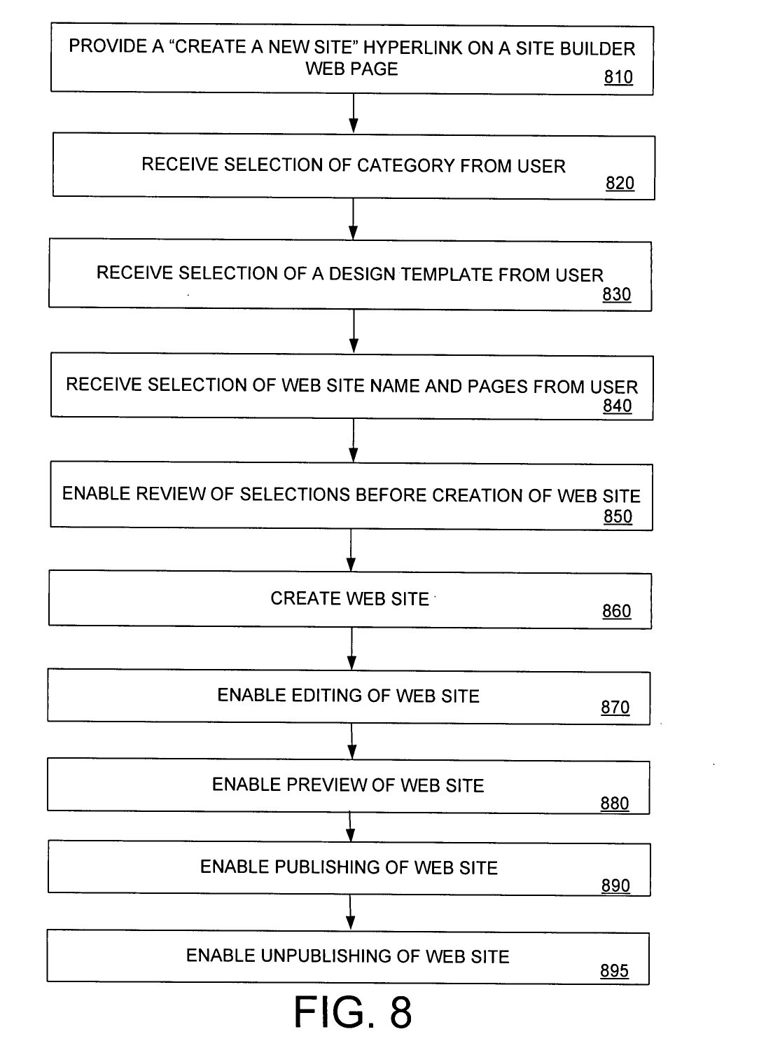

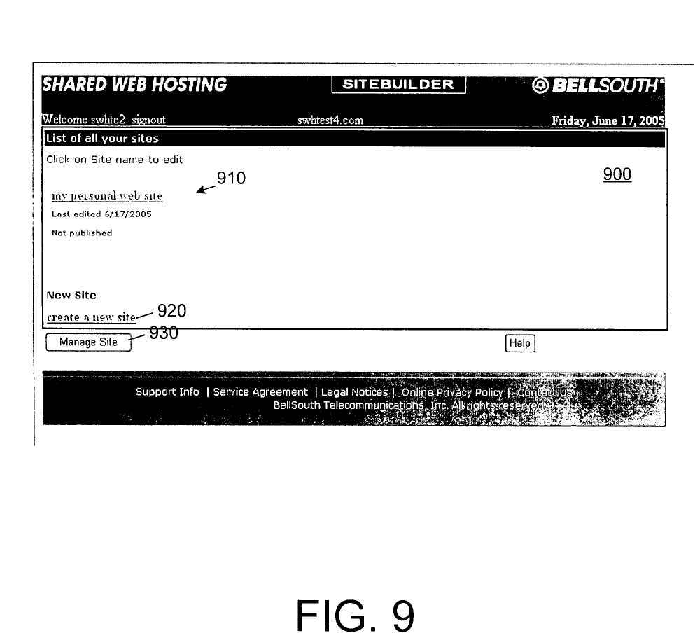

Referring now to FIG. 8, a process for creating a web site in accordance with an embodiment of the present disclosure is described. For example, in one embodiment, a list of all sites on a main page of a site builder application interface is provided, where the sites have been previously created by a user using the site builder application 220. In addition to the listing of the sites 910, a “create a new site” 920 hyperlink is provided (810) on the page 900, in one embodiment (FIG. 9). An exemplary screenshot of one implementation of a page of the site builder application 220 is shown in FIG. 9.

In creating a site, receipt (820) of a selection of a category; receipt (830) of a design template; and receipt (840) of a selection of a web site name and pages from a user are made. Selection of a category provides the suggested templates to start development of a web site. Selection of a design template provides suggested layout and content to start development of the web site. As previously described, a template provides a user with web-ready pages designed for a type of web site such as business, personal, photo album, or vacation site. Each page has sample text and pictures that a user can use as is, customize, or replace with his or her own contents.

To choose a web site name and pages, a user may type a name and select inbuilt or predesigned pages for the user's web site via the site builder interface. The name that is specified when the user creates a web site is the name of both the web site and its home page. A user's web site can have as many pages as the user needs, and the pages that the user selects will already be in the web site when the user starts editing it. A user can later add, copy, move, and delete pages using options and tools (e.g., Manage Site button 930 of FIG. 9) provided in the web pages themselves in the development environment.

In designing and creating the web site, a user can type the name the user wants to assign to his or her web site and its home page. The user can add a footer by adding text that will display as footer at the bottom of every page in the user's site. In choosing pages for the user's site, the user can review (850) the list of pages the user would like to be created with the site and remove the checkmark from any page the does not want to be created with the web site, in one embodiment. Then by choosing an option for creating a site (e.g., “create a new site” hyperlink 920 of FIG. 9) provided by a web-based site builder application 220, the user initiates (860) creation of the web site.

Once a user is finished with creating a site, a user can edit (870) the content, attributes, or layout of the site. For example, each page has sample content that a user can keep, revise to suit the user's needs, or replace with the user's own content. Whether starting with sample content or building a site from scratch, a user can add, edit and delete text; add, replace and delete an image; add, edit and delete a hyperlink; create, edit and delete HTML tables; move, copy and delete one or more above objects together; add, edit and delete pages of the site; copy, move the pages in the user's site; change the design of the page; etc.

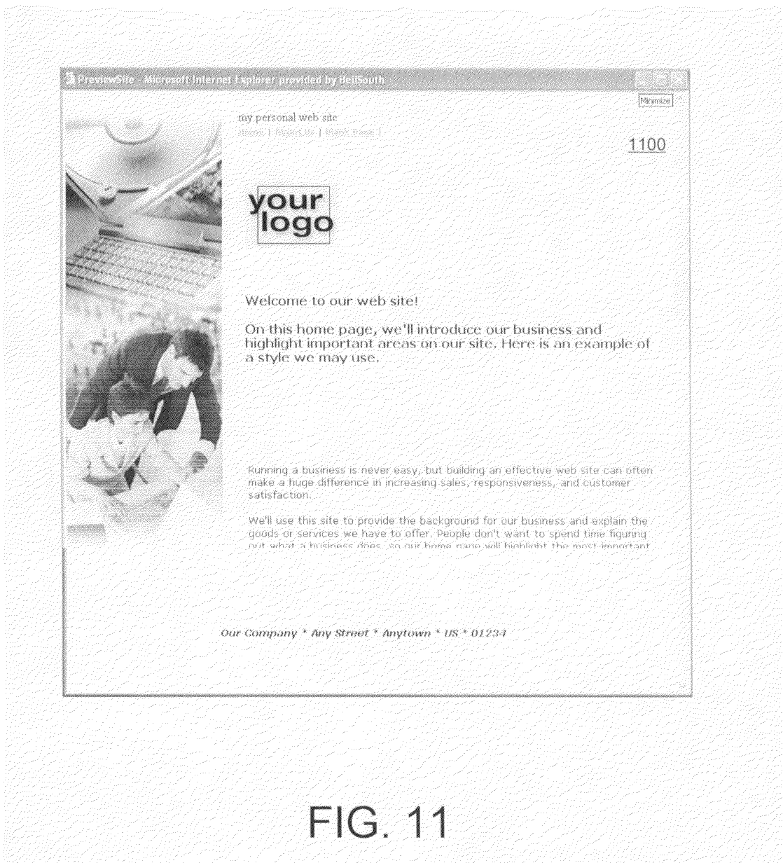

At any time after creating a web site, a user can preview (880) his or her site and its pages to see how it would look like when published to the user's web hosting account in the production environment. This will provide a view of the web site as visitors would see it. In one embodiment, a click of the “Preview” button 1010 on the Edit Site page 1000 facilitates this function, as shown in a screenshot representation of an interface 1000 for editing a web page in FIG. 10. When activated in the development environment, the web site is displayed in a separate browser window as it will appear to the user's visitors. A user can continue editing his or her web site and then refresh the preview window 1100 to see the user's changes, as represented by the screenshot of FIG. 11.

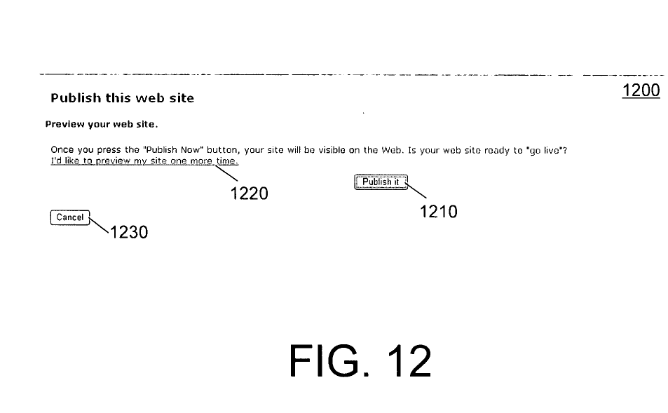

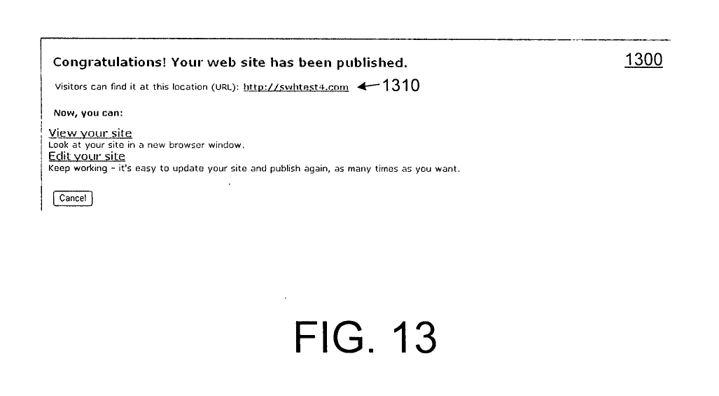

Once a user has completed building his or her web site, the user can publish (890) the site to his or her domain where the user hosts the actual web site, which is viewed as the user's web site for visitors in the production environment. Whenever a user changes his or her web site, it is important to publish again in order to see those changes on the World Wide Web. To do so, a user can click on “Publish this Site” button 1020 on the Edit Site page 1000. If this is the user's first time publishing a site, the user will be asked to enter the address of the published site where the HTML files of the user's web site will be copied. By default, the address will be same as the user's current web site folder name in the site builder platform. After selecting the “Publish this Site” 1020 button, the user is presented with a Publish this web site page 1200 that prompts the user to select a “Publish it” button 1210 (FIG. 12) to publish the site, to choose to preview the web site once again before choosing to publish the site (via the “I'd like to preview my site one more time” hyperlink 1220), or to choose to select the “Cancel” button 1230 to return to a prior page. The publication process may take some time depending upon the size of the user's web site and number of pages it contains. At the end of the process, HTML files will be placed in the user's Linux/Windows account where the web site is hosted and a user will be presented with a confirmation page 1300 (FIG. 13) informing the user that the page has been successfully published and provides a location (e.g., uniform resource locator) 1310 where the site can be accessed.

If at any point of time, a user wants his or her web site not to be visible to outside world, the user may unpublish (895) his or her web site. Choosing to unpublish the web site causes deletion of the HTML files and folders from the user's web site (WWW) but will not delete or change anything to the web site files being stored as part of the site builder platform. It is noted that the user's web site on WWW is just a copy of the user's work that the user has stored as part of the sitebuilder platform. The user can go directly to his or her web site (WWW) and delete these HTML files, and it will not change/delete anything to the user's web site in the sitebuilder platform. Also, the user can publish the user's HTML files again as long as the user does not delete the user's web site development files from the site builder platform.

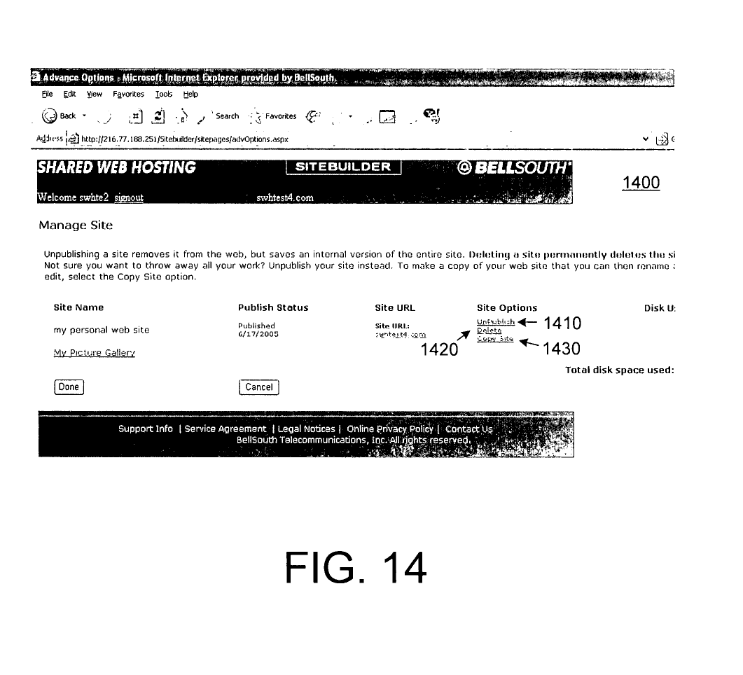

For example, to choose to unpublish a site, a user can click on the “Manage Site” button 930 on List of All sites page 900. Then, a Manage Site page 1400 is displayed, as shown in FIG. 14. On this page, an “unpublish” hyperlink 1410 is provided if the web site being viewed has been published by the user. However, if a user's site is not published yet, the user will not see this link, since the user does not need this functionality.

In one embodiment, deleting a site by selection of “Delete” hyperlink 1420 and responding to the resulting pages will delete the web site from the site builder platform and from the user's web site (WWW). In some embodiments, there is no undo functionality to get the site back once it has been deleted. However, deleting a site will not delete any of the images, which are part of a user's image gallery. Rather, only web site pages and its contents are deleted. In one embodiment, to delete a web site, a user may click on the “Manage Site” button 930 on List of All sites page 900 and click on the “delete” hyperlink 1420 corresponding to a site which a user wants to delete on the Manage Site page 1400. This will take the user to a confirmation page (not shown) where the user has an option not to delete a web site or click on a “Yes” button to permanently delete the web site. Selection of the “Yes” button will delete the web site from the site builder platform in development environment as well as from the user's web site (WWW) in a production environment.

In one embodiment, from the Manage Site page 1400, a user can also elect to create a copy of a current site. This option allows a copy of the user's site to be made before the user edits or changes the site. The user may or may not publish this copy. This also helps in making similar web sites avoiding unnecessary duplicate works.

To copy a web site, in one embodiment, a user may click on a “Manage Site” button 930 on List of All sites page 900; and click on “Copy Site” hyperlink 1430 corresponding to a site for which the user wants to create a copy. This will take the user to a copy site page (not shown) where the user will be asked to enter the name of for the site to be copied; and enter the web site name of the copied site.

After creating a site, a user can also add pages to his or her site. For example, the user can add as many pages as the user wants. It is noted that each page created is based on the design of the site the user has created. If the user wants to change the design/layout of a page, then the user can opt to do this by changing the design.

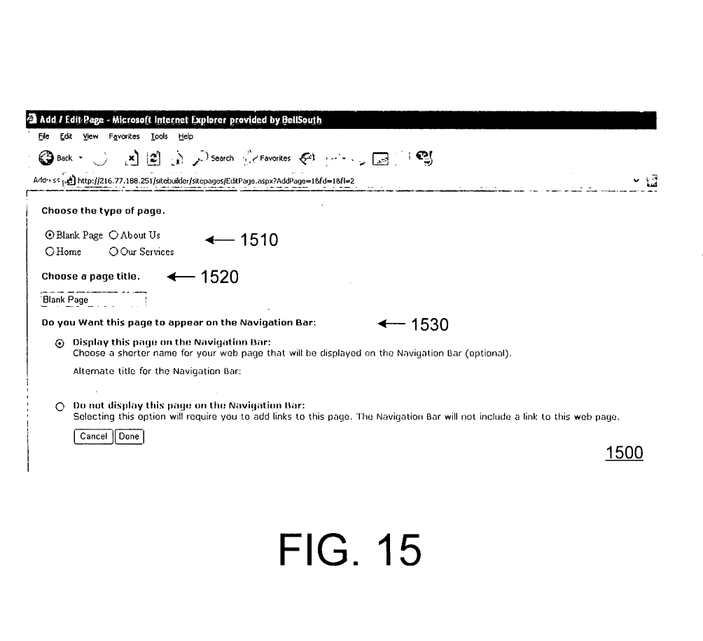

In particular in one embodiment, to create a page, a user may click on an “Add page” button 1430 on Edit Site page 1400. This will take the user to an interface 1500 for adding a page, as illustrated in FIG. 15. From this page, the user can choose the type of page to be added via a group of selection of radio buttons 1510. For example, a user can check the built-in or predesigned pages for this category of web site which has already been created, or the user can select the Blank page option if the user wants to create a page of his or her own.

In one embodiment, the user is also provided a box to “Choose a Page” title 1520 where the user can type a name for the page being added. An option 1530 is also provided for choosing whether to have a hyperlink to the page appear in the navigation bar. This option 1530 is provided for all pages except the index page of the web site in some embodiments. This option 1530 will show or hide the user's web page in his or her site by showing/not showing the page link in the navigation bar of each pages of the site.

It is noted that a web page generally includes many elements like text, images, tables, links and the user can edit each of them and add as many elements as the user wants during development. Each of these elements can be deleted, copied and moved from one place to another in a page during development. In one embodiment, each page is provided with design table object and all these elements belong to it. The design table object is the building block, which determines the layout of the template 230.

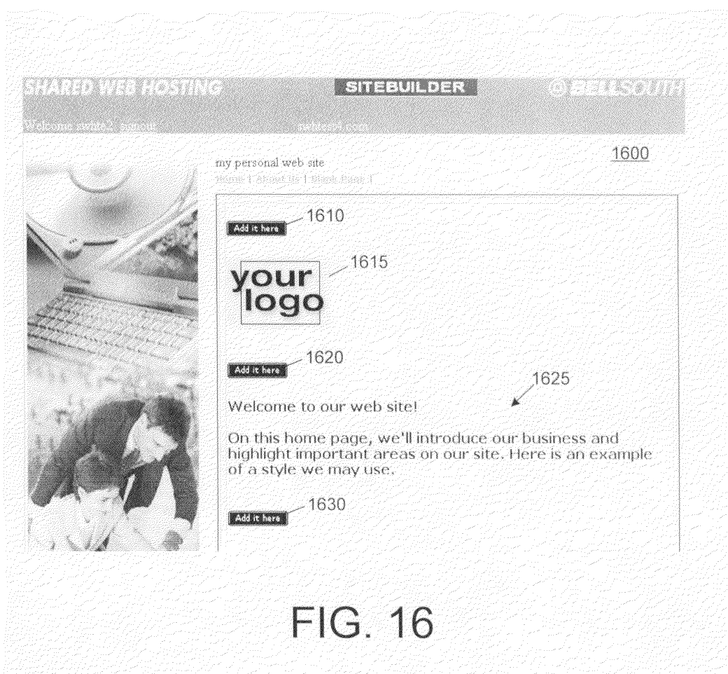

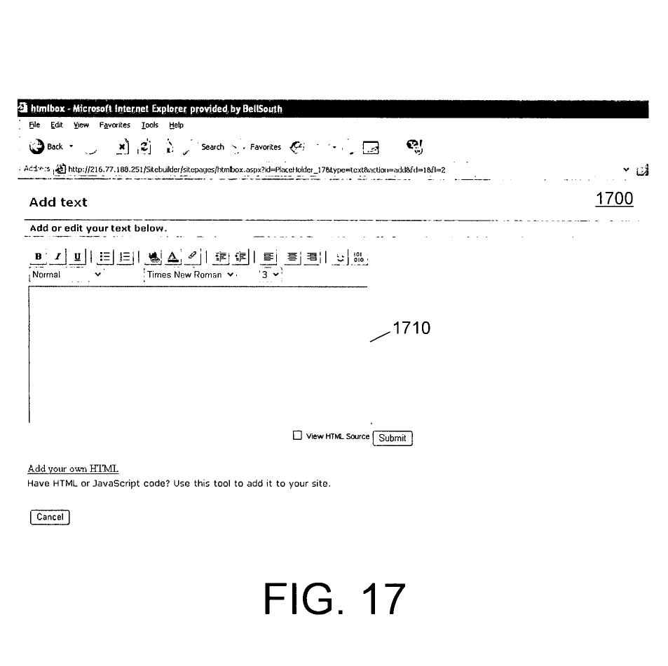

To edit a page, a user may click on the “Manage Site” link 930 on List of All Site page 900. It will take the user to an Edit Site Page 1000. By clicking on any edit button on the page associated with one of the displayed elements or by using tool button listed at the bottom of the page to add new elements, the page 1000 may be edited. For example, clicking on “Add Text” button or link 1080 at the bottom of the page, a user is shown a page 1600 with buttons “Add it here” 1610, 1620, 1630 located at locations where text may be added to the preexisting contents of the web page in the development environment. In the example screenshot shown in FIG. 16, text may be added before the logo image 1615 or between the logo image 1615 and text 1625 at the location marked by button 1620 or after the text 1625 at the location identified by button 1630. By clicking on any of these “Add it here” buttons, a user can indicate where the user would like to add the text. A text editor 1710 is then provided in a new page 1700 so that the user can compose his or her text message to be added, as shown in FIG. 17. In this way, the user has an option to change font style, color, bulleting, paragraph, etc. most of the word processing functionality via the text editor. In one embodiment, a user can type in some text messages and apply font/styles/formats using toolbar of the text editor and click on “Submit” button to add the text at the selected position. Further, options are provided to edit text, delete text, or copy and move text.

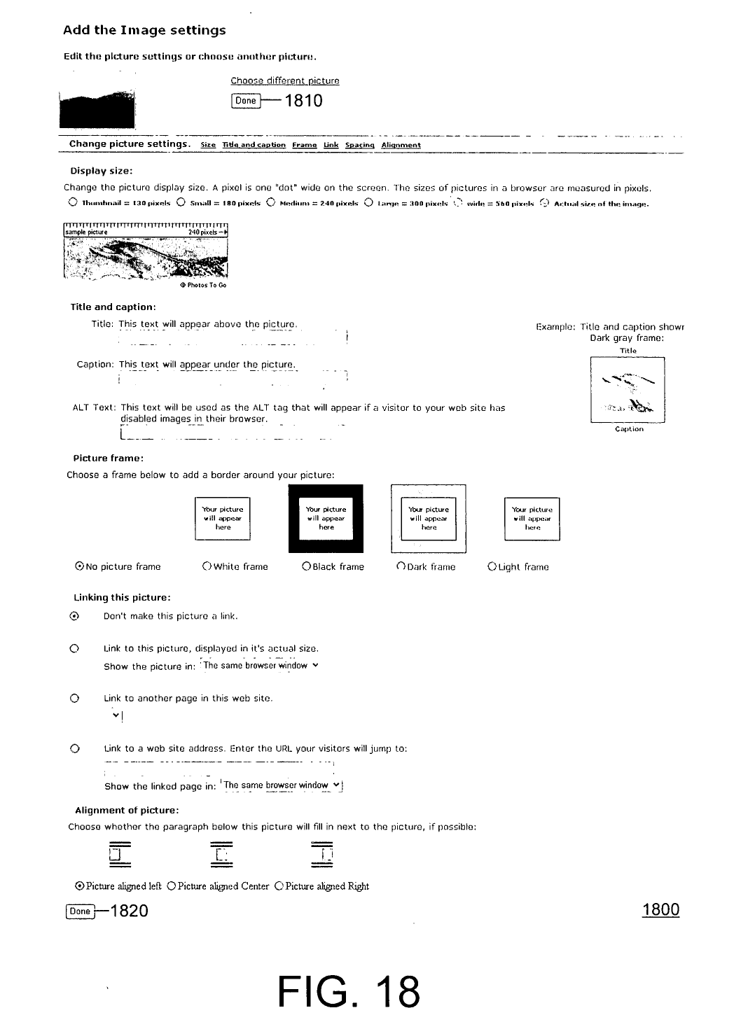

Similarly to text, images can be added at any place on an Edit Site page 1000 where an “Add it here” button shows up in some embodiments. Every user may have an image gallery where user can upload images and use it any place in the site under development. In this way, an image may be uploaded once and image links provided at as many places and as many times in the site, as desired without uploading an image repeatedly. In one embodiment, steps to upload an image include clicking on an “Add Image” button 1070 on the Edit Site page 1000. This will bring the user an Edit Site page with “add it here” buttons at many locations on the page (similar to FIG. 16) to add image at those positions on the page. By clicking on any “add it here” button where the user would like to add his or her image, an image library page (not shown) is then displayed where the user can view all the images uploaded to the user's image gallery or library. Clicking on a “Choose” link next to a displayed image selects an image for that place, in one embodiment. Further, an image properties page is displayed, as illustrated in FIG. 18. In one embodiment, from this page 1800, settings for the selected image may be configured by the user. After editing the settings, the user can click on a Done button 1810, 1820 to submit the image, which will be shown on the web site under development. Further, in some embodiments, options are provided to edit and delete images, copy and move images, change image properties, and view the image gallery. In the present example, the image gallery may also be accessed by activating the My Picture Gallery link 1440 from the Manage Site page 1400.

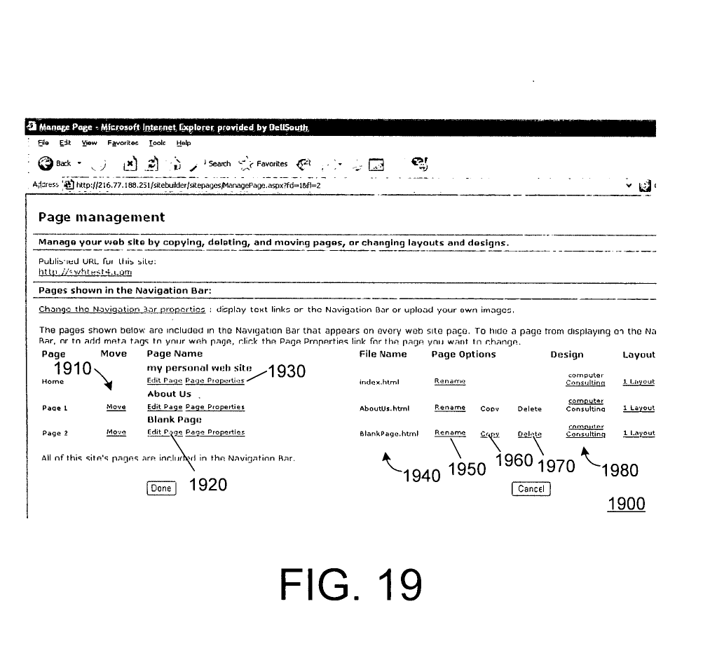

By selecting the Manage Page button or link 1040 at the bottom of the Edit Site page 1000, a user can access a Manage page 1900 which shows all the functionality and options for all the pages of a user's site. In one embodiment, it shows two categories of pages: (1) All those pages which are visible in navigation bar of the user's site; and (2) All those pages which are hidden or are not visible in navigation bar. In the exemplary screenshot of FIG. 19, all of the sites are included in the navigation bar so only one category is being shown.

Manage page 1900 gives a user options to manipulate pages of the user's site. In one embodiment, these are the options available: Move hyperlink 1910; Edit page hyperlink 1920; Page Properties hyperlink 1930; File Name 1940; Rename hyperlink 1950 (e.g., rename page title); Copy hyperlink 1960; Delete hyperlink 1970; and Design Name 1980 (e.g., page design template name). It is noted that the user can delete any pages of his or her site except the index page, in one embodiment. Further, to delete a page, the user can click on the “Manage Page” button 1040 on Edit Site page 1000; and click on the “delete” link 1970 corresponding to page which the user would like to delete, in one embodiment.

In one embodiment, if the user deletes any of his published web pages or any of his published sites then those web page and web sites are written in a DeletedUsersSetings.xml file which has similar format as userSettings.xml. At the time of publishing the site, the site builder application 220 will use this file to delete any pages or site content from the actual web site (web hosting platform).

In one embodiment, a user also has the option to rearrange the navigation bar of the user's site. If a user creates a page, its link is added at the end of the navigation bar of the site, which appears on all the pages of the user's site. If the user would like to move the link of a page from last to first after home page, the user can use a move function. Steps to move a page in accordance with the move function include clicking on the “Manage Page” button 1040 on Edit Site page 1000; and clicking on the “Move” link 1910 corresponding to the page which the user would like to move, in one embodiment. This will bring the user a Move page (not shown) with option to click to where the user wants to move to; and clicking on a “move it here” button where ever the user would like to move the page up/down the navigation bar.

Selection of the Add Link button 1085 from the Edit Site page 1000 allows a user to add a link to the web site in a similar manner as adding an image or text. Accordingly, links can be edited, deleted, and copied and moved by the user, in one embodiment. Further, link properties can be configured as also a designation of the type of link. There may be multiple types of links used in the site builder application. One is to access another web page where the user specifies the HTTP URLs. Another is for mailing a message where the user can create email link. The third is to access another page in the site where the user can add a link to go to other pages of the same site.

In some embodiments, dynamic content may also be added such as controls to portal sites that provide a weather feed or news feed. For example, the site builder application 220 may allow for a control to be added as the page is being developed that will be rendered to contain the information contained in a respective feed associated with the control. Accordingly, multiple controls for dynamic content could be used such as for news, weather, chat, search, counter, etc.

In one embodiment, the user can change the design and layout of his or her page, where the change is designed for the selected page only and will not be applied to all the pages of the site. By changing the design or layout, this will not change or remove any of the user's contents of the page. Only a look and feel of the page will get change and the user's original contents may be placed according to a new design.

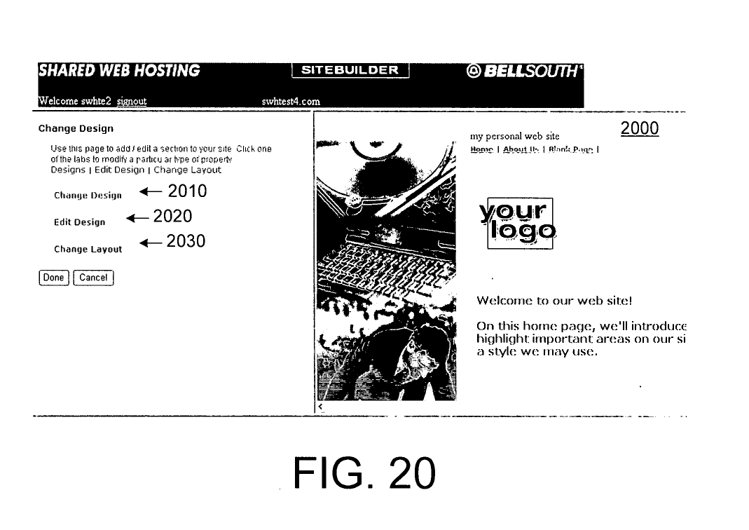

For example, the user can change the user's design in multiple ways. One way is editing a preexisting design. In this way, the user can change his or her page design by changing some of the properties of the page like background color, background images, etc, by selecting the “Page Properties” link 1930 of FIG. 19. Alternatively, the user can change the design, in some embodiments. For example, the user can select a new design all together and replace his or her original design by a new design by selecting the “Change Design” button 1060 of FIG. 10 which launches a Change Design page 2000 of FIG. 20. The Change Design page provides the options to Change Design 2010, Edit Design 2020, or Change Layout 2030.

In constructing the layout for a web page, the site builder application 220 composes the web page in multiple regions, in some embodiments. For example, a header may be in top region of the page, the footer in a bottom region of the page, the navigation bar in a left region of the page, and the body of the page in a right region. Alternatively, some of the content of the body of the page may be in a top right region and some in a bottom right region. If the layout is desired to be changed, a translation process may be performed to move the content from the old layout to the new layout.

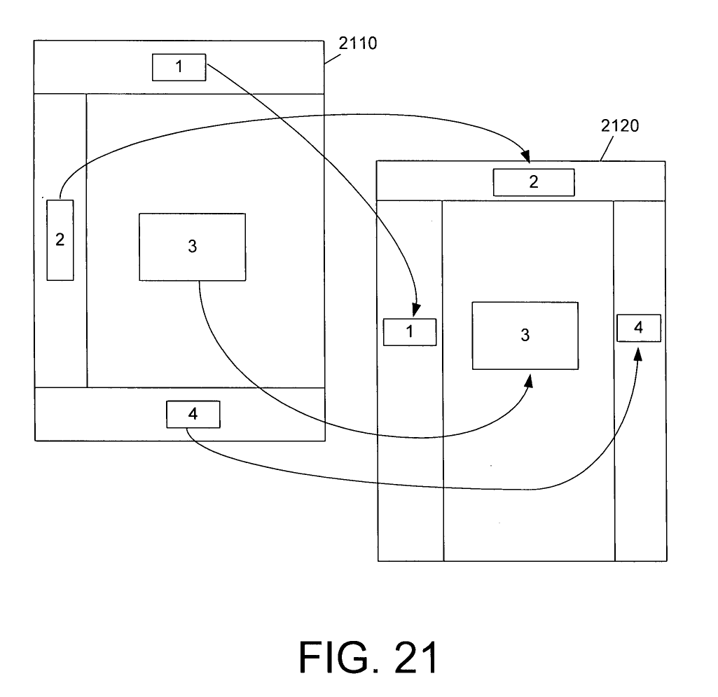

For example, if a new layout is composed of a top region, a left middle region, a center middle region, and a right middle region, the content from the top region of the prior layout 2110 (denoted as “1” in the figure) may be moved to the left middle region of the new layout 2120, the content from the left region (denoted as “2” in the figure) moved to the top region, the content from the right region (denoted as “3” in the figure) moved to the middle center region, and the content from the bottom region (denoted as “4” in the figure) moved to the right middle region, as generally shown in FIG. 21. An advantage of translating regions of content and information from one layout design to another layout design is that information in each region is maintained and translated to a corresponding region. It is noted that the layout of a web page can be composed and divvied up into a multitude of regions in accordance with the present disclosure.

In one embodiment, stylesheets may also be selected by a user so that styles may be applied to the controls without having to define individual attributes for the controls each time one is selected. After selection of a stylesheet, a control that is added to a web site being developed is configured to have the attributes corresponding to the chosen style in the development environment. Therefore, individual objects being added to a web page may adopt features defined by a stylesheet selected for the individual object.

As previously referenced, from the Page Properties page (that is viewed in response to selection of the Page Properties link 1930), the user has an option to change the title and navigation bar option for the page, in one embodiment. The navigation bar option allows a user to check whether the user wants that page to appear on navigation bar or not. This navigation bar option is for all the pages except the index page of the site, in some environments.

A page title comes at the top of every page depending upon the template design and its title as well as its font style can be changed. Steps to change title and its font style include clicking on the “Edit” button 1060 on the side of the page title 1065 on Edit Site page 1000. In one embodiment, this will take the user to an Edit Header page (not shown). On the Edit Header Page, the user has an option to change the page title and font style settings for the page title.

The site builder application 220 allows a user to dynamically generate his or her web site in seconds by using template creation, dynamic page generation, development site storage, and publishing mechanisms. The portable and extensible design of the site builder application 220 allows complete web based design for online design and publishing and same page generation mechanism used for preview and publishing. As a result, a preview of a web site in development closely matches with the actual production version of the web site providing a WYSIWYG (What You See is What You Get) effect. Since site builder controls and attributes are implemented on top of Microsoft's ASP.NET controls and attributes in some embodiments, this makes storing and adding new attributes very easy to implement. Further, ASP.NET control's render functionality is used in some embodiments while generating HTML pages during publishing and preview which makes the published web sites code compatible across a wide range browsers. While publishing, FTP is used to transfer the files to the production servers, which makes the site builder application platform independent. Using ASP.NET control's render option of targeting a particular device such as cell phone, handheld, IPTV (Internet protocol television) may be used, since ASP.NET controls within a web page may be rendered for compatibility with the particular device that requested the page.

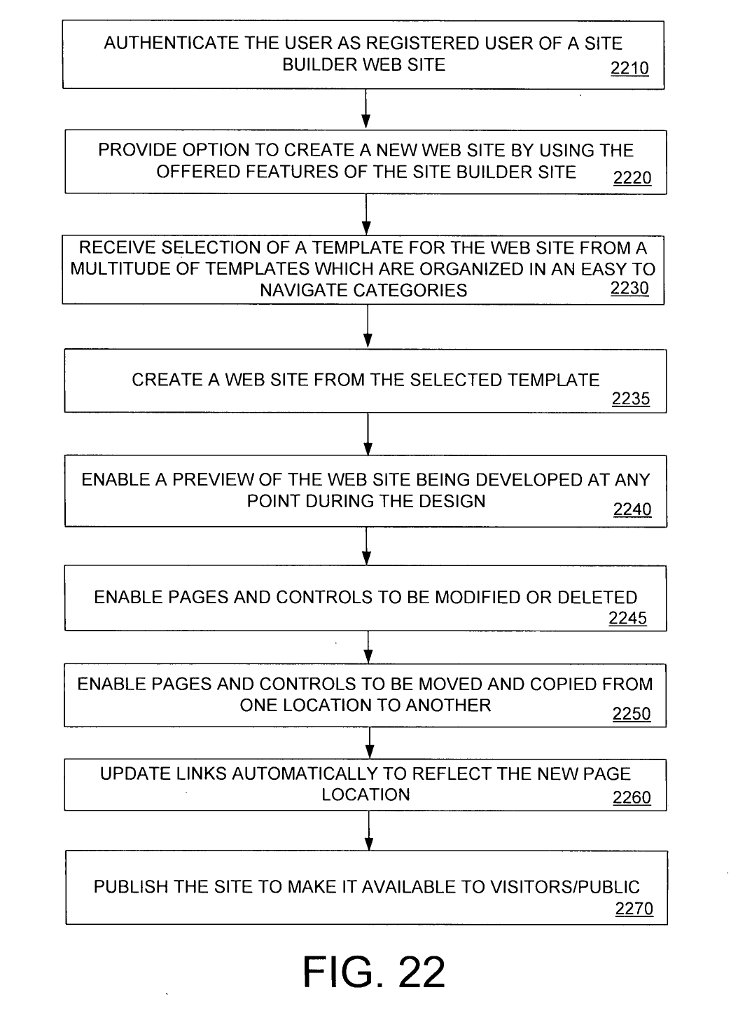

Referring now to FIG. 22, a flow chart of a process for creating a web site in one embodiment is shown. In accordance with this process, a user logs into a site builder web site in order to authenticate (2210) the user as registered user of the site. After logging into the site, the user opts to create (2220) a new web site by using the offered features of the site builder site. Accordingly, the user chooses a name and title for the web site that is to be built. A template for the web site is also selected (2230) from a multitude of templates (e.g., over 300 and may be in excess of a 1000) which are organized in an easy to navigate categories. The selected template defines a general layout to start. However, individual pages may be completely customized also. Accordingly, from the selected template, a web site is created (2235).

The user may preview (2240) the web site that was created and is being developed at any point during the design. Further, pages may be added, based on the selected template or it may be based on another template. It is noted that any number of controls such as tables, text, pictures, internal and external links, forms, toolbar may be added on the web pages being developed using a very simple user interface provided by the pages of the site builder site.

Accordingly, pages and controls may be modified, or deleted (2245). Pages and controls may also be moved and copied (2250) from one location to another with a few mouse clicks, for example. Links are then updated automatically (2260) to reflect the new page location. Once designed, the site can be published (2270) to make it available to visitors/public. In one embodiment, a user is provided an option of generating either HTML pages or ASP pages for publication. Further, the user may be provided an option of having complete or absolute URLs within the generated pages (e.g., http://www.mygreatbusiness.com/our-products/catalog.htm) or partial or relative URLs (e.g., our-products/catalog.htm).

Design and production environments are separate so any changes made at design time are not visible to the site visitors. One copy of the previous production version is retained every time a site is published. In some embodiments, multiple sites are allowed per user or customer.

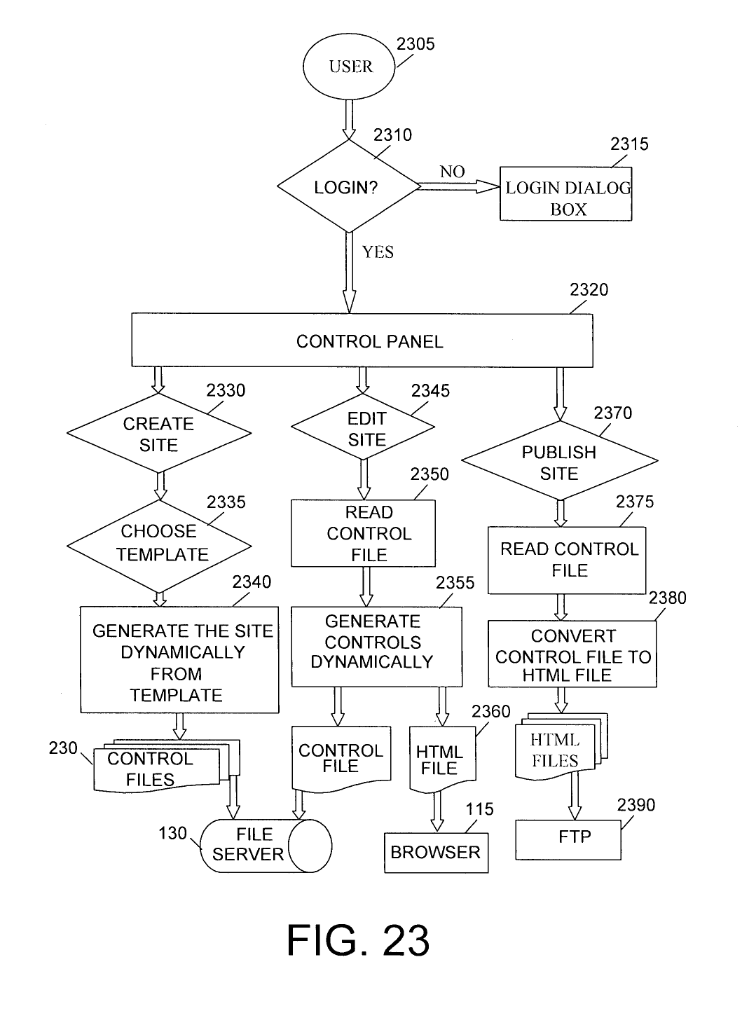

The flow chart of FIG. 23 shows another embodiment of a process for creating a web site using the site builder system. As an optional initial step, the site builder application 220 may be configured to require a user 2305 to log into (2310) the site builder application 220 via a login dialog box 2315. The login dialog box 2315 is an object that is presented to a user to be authenticated in order to have access to a file, to a web page, to a web site, or to an application, etc. If the login is successful, the user is displayed a control panel 2320 for choosing on which path to proceed. FIG. 7 shows one embodiment of a control panel screen of the site builder application 220. If the login is not successful, the user is presented an interface to the login dialog box 2315 so that the login may be attempted again by the user 2305.

From the control panel, a user can choose to either create a site, edit a site, or publish a site. If the user chooses (2330) to create a site, the user is presented screens from the site builder application that allow the user to choose (2335) a template upon which a site is dynamically generated (2340) from the template. The resulting files, such as control files 230 (FIG. 2) that are generated in response to the user's selections are stored in a file server 130.

If the user chooses (2345) to edit a site, the site builder application 220 reads (2350) a control file from the file server 130 that represents the site selected by the user. The site builder application 220 also generates (2355) controls dynamically via a render process in response to selections made by the user in an editing process. Updates to any changes made to the controls are stored in the file server 130. Also, HTML files 2360 are rendered from the controls and displayed to the user via the user's browser 115 so that the user can see how content is displayed after edits have been made.

If the user chooses (2370) to publish a site from the control panel, the site builder application 220 reads (2375) a control file representing the site from the file server 130. The control file is then converted (2380) to one or more HTML files 2360 that are transferred (2390) to the web server 150 (FIG. 1) hosting the HTML files for the web site (e.g., via FTP). For example, in one embodiment files in an ASP.NET format are converted to files expressed using HTML language.

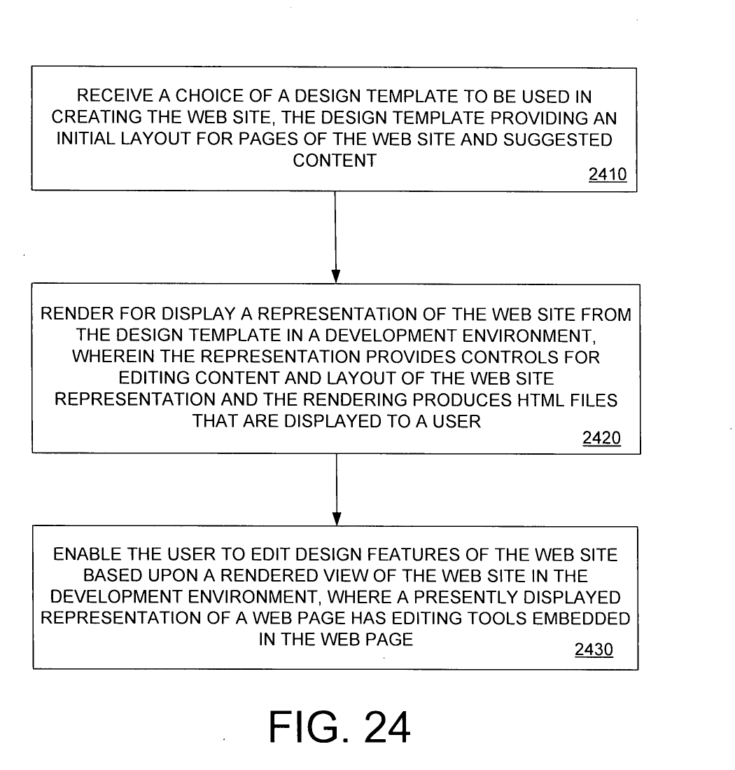

In another example, FIG. 24 is a flow chart depicting of another embodiment of a process for creating a web site. The flow chart includes the steps of receiving (2410) a choice of a design template to be used in creating the web site, the design template providing an initial layout for pages of the web site and suggested content; rendering (2420) for display a representation of the web site from the design template in a development environment, wherein the representation provides controls for editing content and layout of the web site representation and the rendering produces HTML files that are displayed to a user; and enabling (2430) the user to edit design features of the web site based upon a rendered view of the web site in the development environment, where a presently displayed representation of a web page has editing tools embedded in the web page.

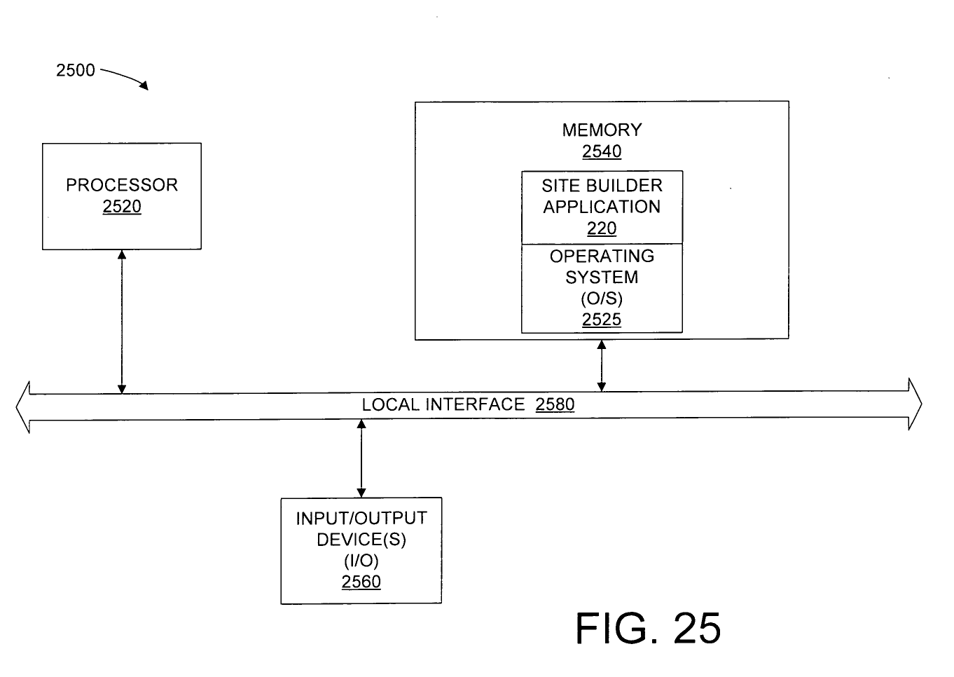

Components of the web site development system 100 can be implemented in software (e.g., firmware), hardware, or a combination thereof. Accordingly, components may be implemented in software, as an executable program, and are executed by a special or general purpose digital computer, such as a personal computer (PC; IBM-compatible, Apple-compatible, or otherwise), workstation, minicomputer, or mainframe computer. An example of a general purpose computer that can implement components of the web site development system 100 of the present disclosure is shown in FIG. 25.

Generally, in terms of hardware architecture, as shown in FIG. 25, the computer 2500 includes a processor 2520, memory 2540, and one or more input and/or output (I/O) devices 2560 (or peripherals) that are communicatively coupled via a local interface 2580. The local interface 2580 can be, for example but not limited to, one or more buses or other wired or wireless connections, as is known in the art. The local interface 2580 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 2520 is a hardware device for executing software, particularly that stored in memory 2540. The processor 2520 can be any custom made or commercially available processor, a central processing unit (CPU), an auxiliary processor among several processors associated with the computer 2500, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 2540 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 2540 may incorporate electronic, magnetic, optical, and/or other types of storage media. Note that the memory 2540 can have a distributed architecture, where various components are situated remote from one another, but can be accessed by the processor 2520.

The software in memory 2540 may include one or more separate programs, each of which comprises an ordered listing of executable instructions for implementing logical functions. In the example of FIG. 25, the software in the memory 2540 includes the site builder application 220 in accordance with the present disclosure and a suitable operating system (O/S) 2525. The operating system 2525 controls the execution of other computer programs and provides scheduling, input-output control, file and data management, memory management, and communication control and related services.

The site builder application 220 is a source program, executable program (object code), script, or any other entity comprising a set of instructions to be performed. When a source program, then the program needs to be translated via a compiler, assembler, interpreter, or the like, which may or may not be included within the memory 2540, so as to operate properly in connection with the O/S 2525.

The I/O devices 2560 may include input devices, for example but not limited to, a keyboard, mouse, scanner, microphone, etc. Furthermore, the I/O devices 2560 may also include output devices, for example but not limited to, a printer, display, etc. Finally, the I/O devices 2560 further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 2500 is a PC, workstation, or the like, the software in the memory 2540 may further include a basic input output system (BIOS) (omitted for simplicity). The BIOS is a set of software routines that initialize and test hardware at startup, start the O/S 2525, and support the transfer of data among the hardware devices. The BIOS is stored in ROM so that the BIOS can be executed when the computer 2500 is activated.

When the computer 2500 is in operation, the processor 2520 is configured to execute software stored within the memory 2540, to communicate data to and from the memory 2540, and to generally control operations of the computer 2500 pursuant to the software. The site builder application 220 and the O/S 2525, in whole or in part, are read by the processor 2525, perhaps buffered within the processor 2520, and then executed.

When the site builder application 220 is implemented in software, as is shown in FIG. 25, it should be noted that the site builder application 220 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The site builder application 220 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), and a portable compact disc read-only memory (CDROM) (optical).

In an alternative embodiment, where the components of the web site development system 100 are implemented in hardware, components can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the embodiments of the present disclosure in which functions may be executed out of order from that shown or discussed, including substantially concurrently or in reverse order, depending on the functionality involved, as would be understood by those reasonably skilled in the art of the present disclosure.

Conditional language, such as, among others, “can,” “could,” “might,” or “may,” unless specifically stated otherwise, or otherwise understood within the context as used, is generally intended to convey that certain embodiments could include, but do not require, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Many variations and modifications may be made to the above-described embodiments without departing substantially from the spirit and principles of the present disclosure. All such modifications and variations are intended to be included herein within the scope of this disclosure.

Therefore, having thus described the invention, at least the following is claimed:

1. A method for creating a web site comprising:
receiving a choice of a design template to be used in creating the web site, the design template providing an initial layout for pages of the web site and suggested content;
rendering for display a representation of the web site from the design template in a development environment, wherein the representation provides controls for editing content and layout of the web site representation and the rendering produces HTML files that are displayed to a user; and
enabling the user to edit design features of the web site based upon a rendered view of the web site in the development environment, a presently displayed representation of a web page having editing tools embedded in the web page, the editing tools comprising tools for editing pre-existing elements of the web page.

2. The method of claim 1, wherein the editing tools comprise tools for adding new elements to the web page.

3. The method of claim 1 further comprising:
moving a page of the web site being developed from a first location to a new location within the web site; and
automatically updating links to the page to reflect the new location.

4. The method of claim 1 further comprising:
enabling a user to preview the web site being developed at any point during creation of the web site in the development environment before the web site is published at a host server in a production environment.

5. The method of claim 4, wherein design and production environments are separate so any changes made at design time is not visible to visitors of the production environment.

6. The method of claim 4, wherein a same page generation mechanism is used for previewing the web site in the development environment and publishing the web site in the production environment.

7. The method of claim 4, wherein the user is provided an option of generating either HTML pages or ASP pages for publication.

8. The method of claim 1 further comprising:
adding a new page to the web site being developed based on a selected design template that is different than the design template used to create the web site initially in the development environment.

9. The method of claim 1 further comprising:
changing a layout of a web page of the web site to a new layout, wherein content from a region of the prior layout is moved to a corresponding region in the new layout at a new location of the web page.

10. The method of claim 1 further comprising:
automatically configuring the web site being developed to adopt a new design selected by the user.

11. The method of claim 1 further comprising:
tailoring presentation of content a web page in the production environment with respect to a particular device requesting the web page.

12. The method of claim 1 wherein in the development environment objects may be added to a displayed web page by defining a type of object to be added and a location for placing the object within the web page being displayed.

13. The method of claim 12, further comprising creating dynamically a control to be stored in the template corresponding to the web page being displayed, the control being configured to render the object being added at the defined location.

14. The method of claim 12, wherein ASP.NET custom controls are used to store individuals object being added.

15. The method of claim 12, wherein at least one individual object being added adopts features defined by a stylesheet selected for the individual object.

16. A computer readable medium having a program for creating a web site, the program having instructions for performing:
receiving a choice of a design template to be used in creating the web site, the design template providing an initial layout for pages of the web site and suggested content;
rendering for display a representation of the web site from the design template in a development environment, wherein the representation provides controls for editing content and layout of the web site representation and the rendering produces HTML files that are displayed to a user; and
enabling the user to edit design features of the web site based upon a rendered view of the web site in the development environment, a presently displayed representation of a web page having editing tools embedded in the web page, the editing tools comprising tools for editing pre-existing elements of the web page.

17. The computer readable medium of claim 16, the editing tools comprising tools for adding new elements to the web page.

18. The computer readable medium of claim 16, the program further performing:
moving a page of the web site being developed from a first location to a new location within the web site; and
automatically updating links to the page to reflect the new location.

19. The computer readable medium of claim 16, the program further performing:
enabling a user to preview the web site being developed at any point during creation of the web site in the development environment before the web site is published at a host server in a production environment.

20. The computer readable medium of claim 16, the program further performing:
adding a new page to the web site being developed based on a selected design template that is different than the design template used to create the web site initially in the development environment.

21. The computer readable medium of claim 20, wherein design and production environments are separate so any changes made at design time is not visible to visitors of the production environment.

22. The computer readable medium of claim 20, wherein a same page generation mechanism is used for previewing the web site in the development environment and publishing the web site in the production environment.

23. The computer readable medium of claim 16, the program further performing:
changing a layout of a web page of the web site to a new layout, wherein content from a region of the prior layout is moved to a corresponding region in the new layout at a new location of the web page.

24. The computer readable medium of claim 16, the program further performing:
automatically configuring the web site being developed to adopt a new design selected by the user.

25. The computer readable medium of claim 16, the program further performing:
tailoring presentation of content a web page in the production environment with respect to a particular device requesting the web page.

26. The computer readable medium of claim 16, wherein in the development environment objects may be added to a displayed web page by defining a type of object to be added and a location for placing the object within the web page being displayed.

27. The computer readable medium of claim 26, the program further performing:
creating dynamically a control to be stored in the template corresponding to the web page being displayed, the control being configured to render the object being added at the defined location.

28. A system for creating web sites comprising;
a development server configured to receive a choice of a design template to be used in creating the web site, the design template providing an initial layout for pages of the web site and suggested content; render for display a representation of the web site from the design template in a development environment, wherein the representation provides controls for editing content and layout of the web site representation, wherein the rendering produces HTML files that are displayed to a user; and enable the user to edit design features of the web site based upon a rendered view of the web site in the development environment, a presently displayed representation of a web page having editing tools embedded in the web page, the editing tools comprising tools for editing pre-existing elements of the web page; and
a production server configured to host the web site after the development server produces HTML files that are transferred to the production server.

29. The system of claim 28, wherein the production server enables a user to preview of the web site being developed at any point during creation of the web site in the development environment before the web site is published at the production server in a production environment.

30. The system of claim 29, wherein design and production environments are separate so any changes made at design time is not visible to visitors of the production environment.

31. The system of claim 29, wherein a same page generation mechanism is used for previewing the web site in the development environment and publishing the web site in the production environment.

32. The system of claim 28, wherein the development server causes different media content to be published at different locations and under different URL translation rules.
